(19) United States
(12) Patent Application Publication
(10) Pub. No.: US 2012/0242540 A1
(43) Pub. Date: Sep. 27, 2012

(54) HEADING DETERMINATION SYSTEM USING ROTATION WITH GNSS ANTENNAS

(76) Inventor: Walter J. Feller, Airdrie (CA)

(21) Appl. No.: 13/426,281

(22) Filed: Mar. 21, 2012

Related U.S. Application Data
(60) Provisional application No. 61/454,635, filed on Mar. 21, 2011.

(51) Int. Cl. G01S 19/47; G01S 19/45

(52) U.S. Cl. 342/357.3; 342/357.28

(57) ABSTRACT

A heading determination system using signals from a global navigation satellite system (GNSS) includes a rotator mechanism for rotating an array of GNSS antennas. The antenna array rotational orientation relative to a structure, such as a vehicle, can be determined by an angular sensor. By rotating the antennas, multipath error can be nullified. Greater GNSS guidance accuracy and heading determination can be achieved by reducing or eliminating multipath error. The system is also adapted for providing output corresponding to the tilt and roll angles for a mobile structure on which it is mounted using two antennas, with the rotation angle being at least 90°.

### CROSS-REFERENCE TO RELATED APPLICATIONS

This application claims priority in and incorporates by reference U.S. provisional patent application Ser. No. 61/454,635, filed Mar. 21, 2011.

### BACKGROUND OF THE INVENTION

1. Field of the Invention

The present invention relates generally to an improvement to a heading determination system and GNSS guidance system, and more specifically to using a rotator to rotate GNSS antennas to improve multipath error correction. By rotating GNSS antennas, the multipath error will be nullified without the need for additional antennas, which results in increased GNSS guidance accuracy and heading determination.

2. Description of the Related Art

GNSSs include the Global Positioning System (GPS), which was established by the United States government and employs a constellation of 24 or more satellites in well-defined orbits at an altitude of approximately 26,500 km. These satellites continually transmit microwave L-band radio signals in three frequency bands, centered at 1575.42 MHz, 1227.60 MHz and 1176.45 MHz, denoted as L1, L2 and L5 respectively. All GNSS signals include timing patterns relative to the satellite's onboard precision clock (which is kept synchronized by a ground station) as well as a navigation message giving the precise orbital positions of the satellites. GPS receivers process the radio signals, computing ranges to the GPS satellites, and by triangulating these ranges, the GPS receiver determines its position and its internal clock error. Different levels of accuracy can be achieved depending on the techniques employed.

GNSS also includes Galileo (Europe), the GLObal NAvigation Satellite System (GLONASS, Russia), Compass (China, proposed), the Indian Regional Navigational Satellite System (IRNSS) and QZSS (Japan, proposed). Galileo will transmit signals centered at 1575.42 MHz, denoted L1 or E1, 1176.45 denoted E5a, 1207.14 MHz, denoted E5b, 1191.795 MHz, denoted E5 and 1278.75 MHz, denoted E6. GLONASS transmits groups of FDM signals centered approximately at 1602 MHz and 1246 MHz, denoted GL1 and GL2 respectively, and 1278 MHz. QZSS will transmit signals centered at L1, L2, L5 and E6. Groups of GNSS signals are herein grouped into “superbands.”

Advances in GNSS guidance seek to improve position determination and heading accuracy by reducing or eliminating errors that naturally occur due to the distance between the tracked object and the satellite in space, hardware and software limitations, and other elements. A significant error source in GNSS heading systems is multipath error.

Spiral-element and crossed-dipole antennas tend to provide relatively good performance for GNSS applications. They can be designed for multi-frequency operation in the current and projected GNSS signal bandwidths. Such antenna configurations can also be configured for good multipath signal rejection, which is an important factor in GNSS signal performance. An example of a crossed-dipole GNSS antenna is shown in Feller and Wen U.S. patent application Ser. No. 12/268,241, now U.S. Pat. No. 8,102,325, entitled GNSS Antenna with Selectable Gain Pattern, Method of Receiving GNSS Signals and Antenna Manufacturing Method, which is incorporated herein by reference.

Multi-antenna GNSS-based machine control and guidance applications include equipment and vehicles of various kinds Such equipment and vehicles can be utilized in such diverse industries as mining, construction and agriculture, for example. Examples of multi-antenna GNSS applications are shown in Whitehead, Miller, McClure and Feller U.S. patent application Ser. No. 12/938,049, Publication No. US 2011/0054729 A1, entitled Multi-Antenna GNSS Control System and Method, which is incorporated herein by reference.

Multipath interference is caused by reflected signals that arrive at the antenna out of phase with the direct line-of-sight (LOS) signals. Multipath interference is most pronounced at low elevation angles, e.g., from about 10° to 20° above the horizon. They are typically reflected from the ground and ground-based objects. Antennas with strong gain patterns at or near the horizon are particularly susceptible to multipath signals, which can significantly interfere with receiver performance based on direct line-of-sight (LOS) reception of satellite ranging signals and differential correction signals (e.g., DGPS).

GNSS satellites transmit right hand circularly polarized (RHCP) signals. Reflected GNSS signals become left hand circularly polarized (LHCP) and are received from below the horizon as multipath interference, tending to cancel and otherwise interfere with the reception of line-of-sight (LOS) RHCP signals. Rejecting such multipath interference is important for optimizing GNSS receiver performance and accurately computing geo-referenced positions. Receiver system correlators can be designed to reject multipath signals. The antenna design of the present invention rejects LHCP signals, minimizes gain below the horizon and forces correct polarization (RHCP) over a relatively wide beamwidth for multiple frequencies of RHCP signals from above the horizon.

Multipath error is caused by objects reflecting the satellite signal to the GNSS antenna(s), causing the receiver to receive a primary signal and a delayed, reflected signal. Using multiple antennas can amplify this error. When two antennas are placed at least a wavelength apart, the multipath signals are uncorrelated. Each antenna “sees” a different combination of delayed signals. This combination establishes errors that deteriorate heading determination accuracy. These multipath errors remain almost constant for several seconds, and typically only changes as the satellite's orbit position changes, changing the angle of the signal reflecting off of other surfaces. Multipath signals can cause errors in the prompt and thereby result in a shifted reference. A shifted reference causes a delay-lock loop to produce an erroneous code phase in GNSS guidance. Therefore, what is needed in the art is a method to mitigate erroneous effects due to multipath signals.

The present invention addresses the aforementioned GNSS heading system issues with multipath error by providing a system which rotates the antennas, allowing the multipath angles to constantly change without the need to rely on changed satellite position.

Heretofore there has not been available a GNSS heading determination system with the advantages and features of the present invention.

### SUMMARY OF THE INVENTION

In the practice of an aspect of the present invention, a GNSS heading determination system is provided, featuring at least two GNSS antennas mounted at least one wavelength apart and placed on a rotating platform. The platform rotates in either continuous circles or cycles clockwise/counterclockwise through predetermined partial revolutions.

### BRIEF DESCRIPTION OF THE DRAWINGS

FIG. 1 is an isometric view of an embodiment of the present invention connected to additional preferred elements.

FIG. 2 is an elevational view of an embodiment of the present invention.

FIG. 3 is a top plan view of an embodiment of the present invention, demonstrating the rotational capabilities featured in the invention.

FIG. 4 is an isometric view of an alternative embodiment of the present invention, demonstrating the invention in conjunction with a marine radar device.

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning Global navigation satellite systems (GNSS) are broadly defined to include GPS (U.S.), Galileo (Europe), GLONASS (Russia), Compass (China, proposed), IRNSS (India), QZSS (Japan, proposed) and other current and future positioning. Said terminology will include the words specifically mentioned, derivatives thereof and words of similar meaning.

The present invention provides a means to improve GNSS heading accuracy using a stepper motor (or other accurate rotator) to rotate the antennas. Two GNSS antennas are rotated in either continuous circles or at least 30 degrees back and forth. By doing this, the multipath angles change constantly and, provided the rotational distance in which the antennas are moved is at least one wavelength, the cancellation effect averages to zero. The wavelength distance (e.g. 19 cm for GPS L1) should be less than the difference between the master and the slave antenna. As an example using GPS L1, if the axis of rotation is in the center between the two antennas more than 20 cm apart and the unit is rotated 360 degrees, the multipath effects will nearly average to zero, resulting in an almost complete reduction in multipath error.

In order to compute a meaningful heading while rotating, the unit must know exactly the rotator angle to correct for this rotator position and provide the vessel's or vehicle's heading. This is easily done with stepper motors, or other motors with sensors, which can know within a small fraction (e.g. ⅙0) of a degree the rotator position. The rotational motor will communicate with the GNSS processor to provide rotation data, allowing the processor to calculate accurate heading and utilize the reduced multipath error.

Without limitation on the generality of useful applications of the antennas of the present invention, GNSS represents an exemplary application, which utilizes certain advantages and features.

### II. GNSS Heading System 2

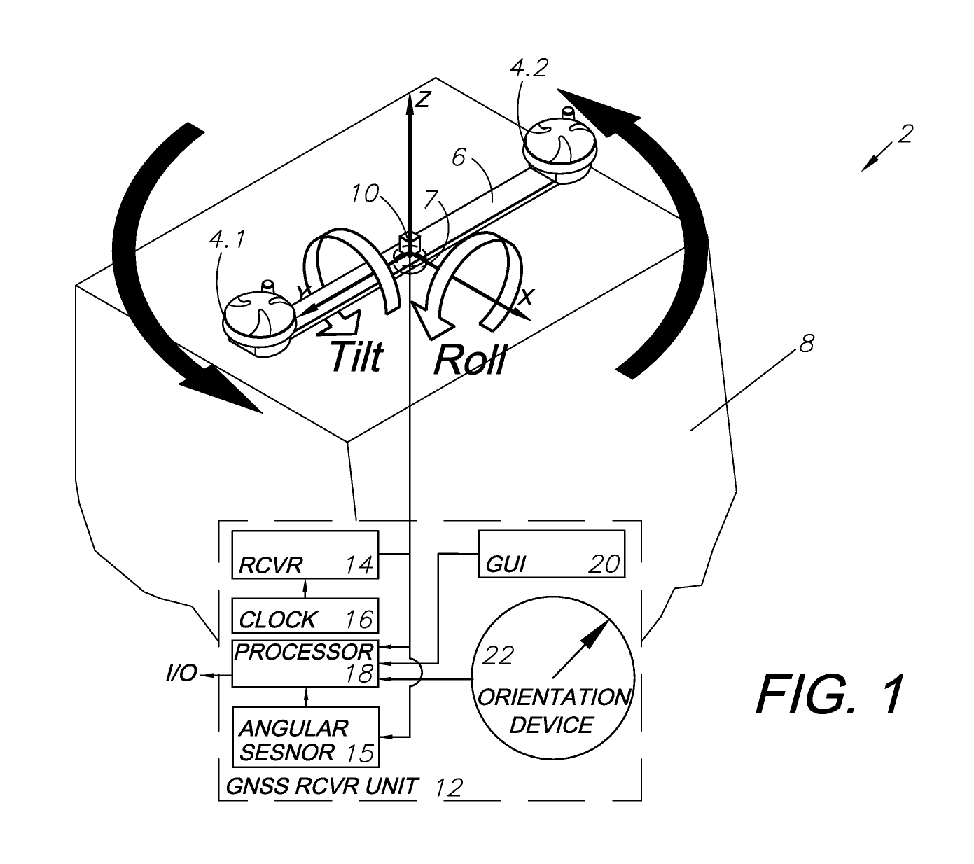

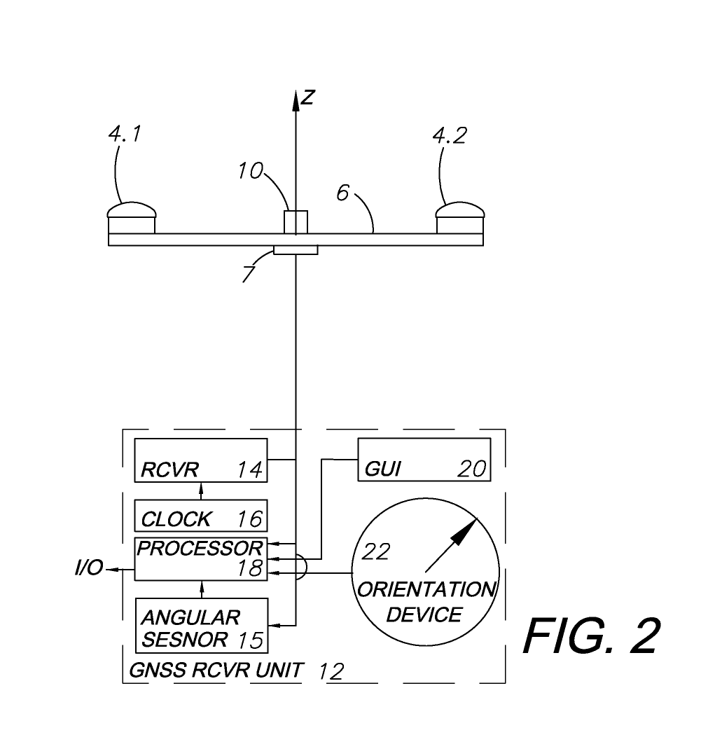

Referring to FIGS. 1 and 2 of the drawings in more detail, the reference numeral 2 generally designates a GNSS heading system, which is typically comprised of at least two GNSS antennas 4.1, 4.2, an inertial measurement unit (IMU) 10, and a GNSS receiver unit 12. The receiver unit 12 is further comprised of a receiver 14, a clock 16, a processor 18, a graphical user interface (GUI) 20 and an orientation device 22. These devices are interconnected and allow GNSS positional tracking of the vehicle 8 as well as heading determination.

A rotation platform 6 and rotation motor 7 are connected to the vehicle 8. The first antenna 4.1 is connected to a first end of the rotation platform 6 and the second antenna 4.2 is connected to a second end of the rotation platform 6. The length of the rotation platform must be at least the length of one signal wavelength, λ. The IMU 10 is also mounted to the platform, preferably near the center. The two antennas 4.1, 4.2 are rotated by the rotation platform 6 and motor 7. The desired rotation angle α is preferably at least 90 degrees, but may be continuous circles or any appropriate angle. This allows the multipath angels to change constantly by at least one wavelength, λ, so the cancellation effect averages to zero.

An angular sensor 15 is included to measure the rotation angle α. The rotation angle α must be known in order for the processor 18 to calculate a meaningful heading. The rotation motor 7 may be a stepper motor or other motor with an angular sensor 15 built into the motor. Typical motors can detect the rotation angle within 1/60 of a degree of the rotation position. Such accuracy is suitable for calculating accurate heading of the vehicle 8.

With this configuration, it is also possible to measure the roll, tilt, and heading of the vehicle 8 with only two antennas 4.1, 4.2. By rotating the antennas at least 90 degrees, the antennas will provide information in the roll and tilt dimensions. For example, as shown in FIG. 1, at 0 degrees of rotation the antennas will be located in the roll plane. When rotated 90 degrees, the antennas will be located in the tilt plane. The height of each antenna in the Z-axis can be determined by GNSS positioning, and the difference will provide the relative roll or tilt of the vehicle 8 at any point during vehicle travel. This allows for redundancy in roll and tilt measurement by the IMU 10, so that errors in positioning and heading can further be corrected. The IMU 10 will be continuously calibrated, and thus more accurate, when satellite signal to the antennas 4.1, 4.2 is blocked. This requires that the IMU 10 be placed on the platform 6 along with the antennas 4.1, 4.2.

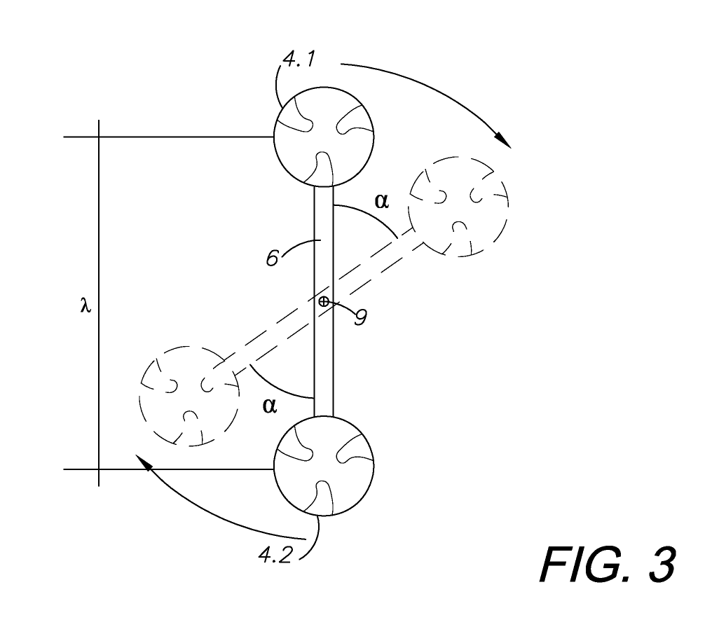

FIG. 3 more clearly demonstrates the relation of the two antennas 4.1, 4.2 during rotation. The antennas 4.1, 4.2 are mounted on opposing ends of the rotation platform 6 a distance λ apart, and rotated about a central axis 9, located midway between the antennas 4.1, 4.2. The rotation angle α must be at least 30 degrees for accurate multipath correction. The direction of rotation is irrelevant. Position data is received at the first antenna location and the second antenna location, and the data is averaged to remove multipath errors common with such heading and positioning guidance systems.

The rotator motor 7 should be capable of rotating the platform 6 and attached antennas 4.1, 4.2 fast enough to ensure the multipath angles have not changed significantly during the rotation period. A rotation period of 10 seconds should be appropriate for most GNSS heading correction purposes. The rotation also must not exceed a rotation speed of 90 degrees per second to ensure proper GNSS antenna function and for proper gyro operation.

III. Alternative Embodiment Antenna Heading Correction with Marine Radar

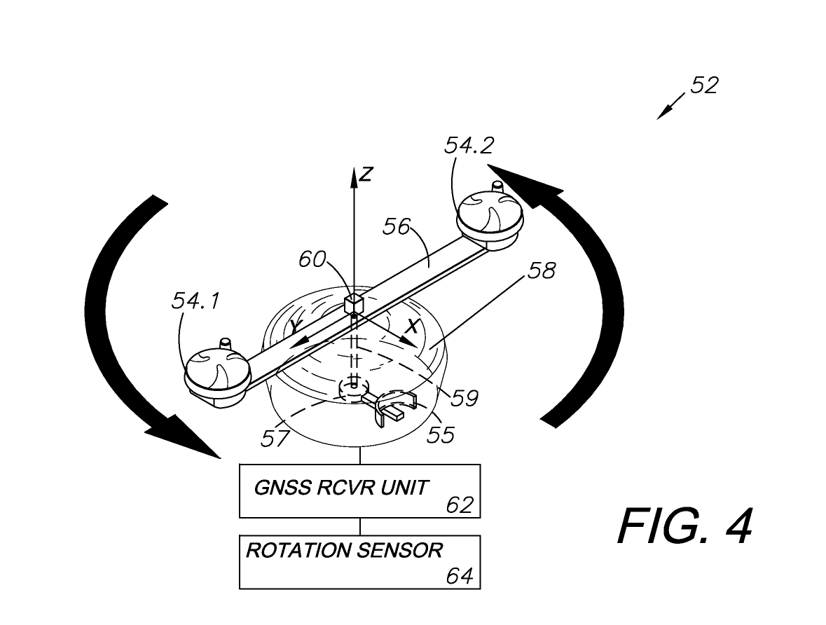

FIG. 4 demonstrates an alternative embodiment of a GNSS heading system 52 employed in conjunction with a marine radar unit 58. The marine vehicle market typically employs radar systems that include regularly rotating antennas 55. These antennas may provide weather data, vehicle detection information, or other relevant data relative to the vehicle's location. A marine radar unit 58 houses a radar antenna and necessary components related to the radar function, such as a separate processor. The rotation value of the radar antenna is necessarily known by the radar processor.

The marine radar also includes a rotation means 57 such as a rotator motor for rotating the marine radar antenna 55. A rotation platform 56 may be attached to the existing radar rotation motor 57 via a connecting axle 59. Two GNSS antennas 54.1, 54.2 are placed on adjacent ends of the platform 56, and an IMU 60 is placed at the center of the platform 56. This allows the GNSS heading system 52 to share the rotation of the radar rotator motor 57, and provides adequate multipath error correction to the attached GNSS system. An external GNSS receiver unit 62 and optional additional rotation sensor 64 are electrically connected to the GNSS heading system 52 and the radar 58 to receive GNSS position data from the GNSS antennas 54.1, 54.2. If the radar 58 includes a separate rotational sensor device, a separate rotation sensor 64 is not necessary.

It is to be understood that the invention can be embodied in various forms, and is not to be limited to the examples discussed above. The range of components and configurations which can be utilized in the practice of the present invention is virtually unlimited.

Having thus described the invention, what is claimed as new and desired to be secured by Letters Patent is:

1. A global navigation satellite system (GNSS) heading and guidance system for a mobile structure, which system comprises:
a primary antenna;
a second antenna adapted for mounting in spaced relation from said primary antenna;
a receiver unit including a GNSS receiver connected to said antennas, a clock and a processor;
a rotating platform adapted for rotatably mounting on said mobile structure;
at least one of said antennas being mounted on said rotating platform in spaced relation from the other said antenna;
a motor attached to and adapted for rotating said platform relative to said mobile structure; and
an angle sensor connected to said platform and adapted for providing an output to said processor, said angle sensor output corresponding to an angle of said platform relative to said mobile structure.

2. The GNSS heading and guidance system of claim 1, wherein:
said antenna separation is greater than the frequency wavelength of signals being received by said first and second antennas.

3. The GNSS heading and guidance system of claim 2, wherein:
said GNSS receiver is adapted for receiving GNSS signals from one or more of the list comprising: GPS L1, L2, or L5; GLONASS; Beidou; and Galileo GNSS systems.

4. The GNSS heading and guidance system of claim 1, which includes:
an inertial measurement unit (IMU) attached to said platform between said first and second antennas and connected to said processor.

5. The GNSS heading and guidance system of claim 1, which includes:
a gyroscope attached to said platform between said first and second antennas and connected to said processor.
